(19) United States
(12) Patent Application Publication
(10) Pub. No.: US 2025/0147800 A1
(43) Pub. Date: May 8, 2025

(54) SCHEDULING BLOCKING OF APPLICATIONS

(71) Applicant: Magichabits Labs Limited, London (GB)

(72) Inventor: Hamel Shah, Kuala Lumpur (MY)

(21) Appl. No.: 18/501,252

(22) Filed: Nov. 3, 2023

(51) Int. Cl. G06F 9/48; G06F 9/54

(52) U.S. Cl. CPC G06F 9/4881; G06F 9/542

(57) ABSTRACT

Disclosed is a method of scheduling a blocking of data processing application execution on a data processing device, comprising the steps of: receiving from an operating system a first plurality of tokens each token representing a respective one of a plurality of applications of a first type that have been selected by a user; storing the first plurality of tokens; receiving at least one application first type time period in which at least one of the plurality of applications of the first type is to be used for, such application first type time period having been selected by the user.

### BACKGROUND

A data processing device, such as a smartphone, tablet computing device, laptop computer, or the like, is commonly used to execute applications which receive input, process data and provide an output as a result of the processing, typically on a display screen of the device. These applications can be directed at a variety of purposes, including both educational purposes as well as entertainment purposes. Usually, a user of such a device can access any application that is already installed on the device without any controls over such access. However, the inventor has found that it would be useful in certain circumstances to be able to provide such controls.

### SUMMARY

Disclosed is a method of scheduling a blocking of data processing application execution on a data processing device, comprising the steps of: receiving from an operating system a first plurality of tokens each token representing a respective one of a plurality of applications of a first type that have been selected by a user; storing the first plurality of tokens; receiving at least one application first type time period in which at least one of the plurality of applications of the first type is to be used for, such application first type time period having been selected by the user; assigning the at least one receiving application first type time period to at least one respective token each representing a respective one of the plurality of applications of the first type, by storing the at least one received application first type time period in association with each of the at least one respective tokens representing a respective one of the plurality of applications of the first type; receiving from the operating system a second plurality of tokens each token representing a respective one of a plurality of applications of a second type that have been selected by a user, the applications of the second type being applications which are to be blocked by the operating system while the applications of the first type are being used on the data processing device; storing the second plurality of tokens; sending to the operating system, an event message which includes the stored first plurality of tokens and the stored at least one application first type time period, in response to which the operating system creates a plurality of device activity events which trigger a monitoring function whereby the operating system monitors an execution on the data processing device of each application of the first type for the at least one first application type time period; and sending to the operating system an event message which includes the stored second plurality of tokens, in response to which the operating system creates a device activity event which sets up a blocking shield which prevents the applications of the second type from being executed by the data processing device during the at least one application first type time period when the plurality of applications of the first type are being used.

Also disclosed is a corresponding system comprising means adapted for carrying out all the steps of the above method.

Also disclosed is a computer program comprising instructions for carrying out all the steps of the above method when the computer program is executed on a computer system.

### BRIEF DESCRIPTION OF DRAWINGS

FIGS. 1A and 1B are a flow chart showing the process flow steps for allowing a user to create and set up a data processing application blocking schedule;

FIGS. 2A and 2B are a flow chart showing the process flow steps for enforcing a data processing application blocking schedule on a user of a client device;

FIGS. 3-15 are screen shots which are displayed on a client data processing device at various steps or stages of the process flow of FIGS. 1A and 1B and 2A and 2B.

### DETAILED DESCRIPTION

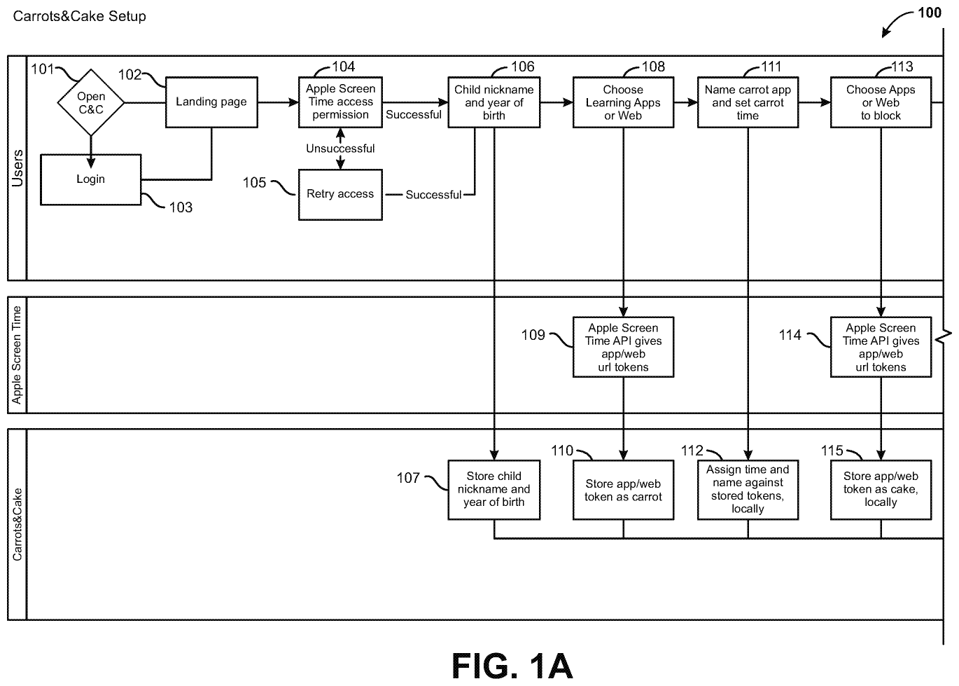

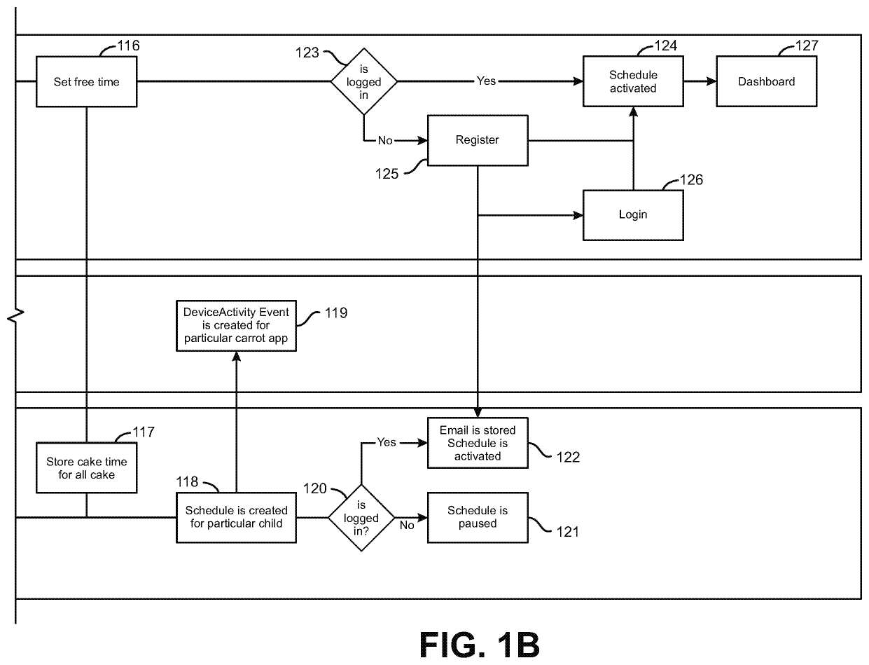

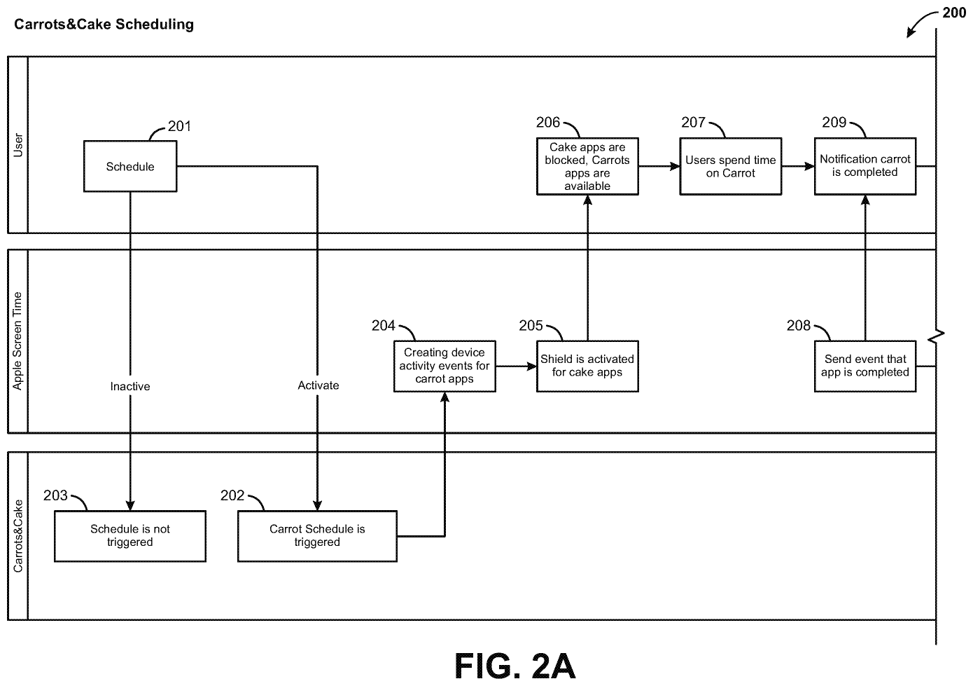

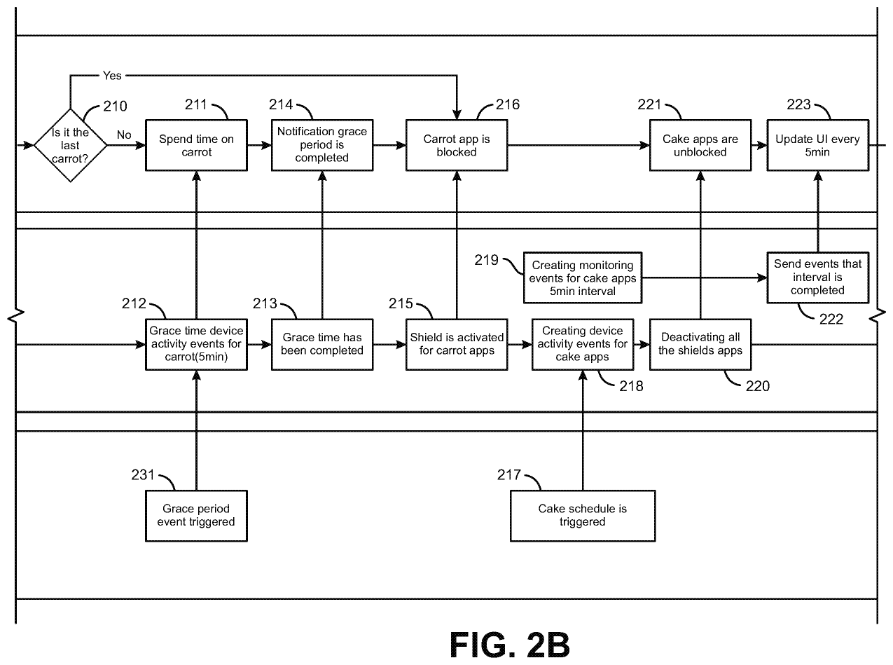

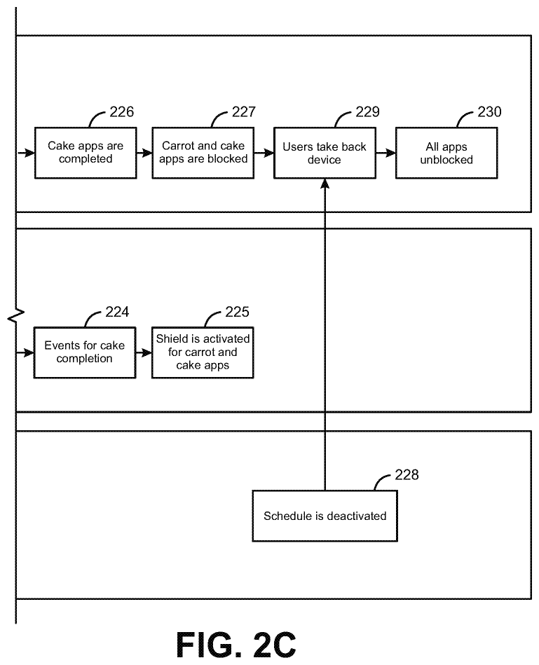

FIGS. 1A and 1B and 2A and 2B each illustrates a three-level flowchart showing activities carried out at each of three logical levels of software functionality, in a data processing system, where a user operates a data processing client device, such as a smartphone, tablet device, laptop computer, or smart TV, to enable the data processing client device to communicate over a network with a data processing server device, to enable the data processing client device to execute software applications which are installed on the data processing client device and to make use of additional functionalities which are available at the data processing server device by the client device making calls over the network to the server device and the server device returning replies over the network back to the client device.

The first or top level of each the three-level flowcharts of FIGS. 1A and 1B and 2A and 2B, shows activities which are carried out by the data processing client device.

The second or middle level of FIGS. 1A and 1B and 2A and 2B shows activities which are carried out by the data processing server device, in response, for example, to requests sent to the server device by the client device. In the preferred embodiment, as shown in FIGS. 1A and 1B and 2A and 2B the second level is performed by a server data processing functionality at, for example, the server operating system level, which monitors a user's access to the client device, such as monitoring how long a user has spent using particular applications on the user's client device, or how long a user has used a client device in a particular day or a particular hour of the day. For example, in the preferred embodiment, the second level functionality is carried out by Apple Incorporated, and specifically is called Apple Screen Time, which is a functionality included as part of Apple's operating system iOS, for running its Apple iphone products, for example. This second-level functionality could be carried out entirely at the client device or it could be carried out at the server device, depending on the preferences of the implementer of the data processing system. While Apple Screen Time is used in the preferred embodiment, it should be clear to the skilled person in the art, that other operating systems, platforms, or software functionality could be used instead.

The third or bottom level of FIGS. 1A and 1B and 2A and 2B shows activities which are carried out by a new data processing application which is installed on the user's client device. In the preferred embodiment, this application is called Carrots&Cake, as it provides an environment to ensure that a child using a client data processing device uses educational data processing applications (the carrots) for a specified period of time before the child is allowed to use an entertainment focused data processing application (the cake). This new data processing application runs on the client device.

Each of the three levels of data processing functionality shown in FIGS. 1A and 1B and 2A and 2B interacts with the other levels, and the arrows in FIGS. 1A and 1B and 2A and 2B show the interactions which take place between the three levels and will be described in detail below.

FIGS. 1A and 1B shows the three-levels of functionality which take place in order to set up the new data processing application (the third or bottom level application) so that it can be later used (as will be described below in conjunction with FIGS. 2A and 2B) to enforce an application schedule which controls for how long (over what time period) a user of the client device is permitted to use each of a selected plurality of applications, and also the sequence (or time ordering) in which the user is permitted to use each of the selected plurality of applications. For example, in the preferred embodiment, the new data processing application at the third level enforces an application blocking schedule over which a child user is only allowed to use a specified first educational application, and must use such specified first educational application for a first set period of time, and then the child user is only allowed to use a specified second educational application, and must use such second educational application for a second set period of time (which could be a different period of time as compared to the first set period of time, or could be the same period of time), and then the child is allowed to use a specified entertainment application for a set period of time (only after the child has used the first and second educational applications for the first and second periods of time, respectively). It should be noted that the child user is not restricted such that the child user must use the first educational application for the set period of time before the child user can move on to the second educational application (the child user could spend, for example, 5 minutes on the first educational application and then spend 5 minutes on the second educational application, and then return to the first educational application and spend a further 10 minutes and then return to the second educational application and spend a further 5 minutes, the first educational application will be considered completed only when the full specified time has been spent by the child user on the first educational application, whether this be in discrete time intervals, or in a continuous time interval, and the same for the second educational application etc).

In FIGS. 1A and 1B, at the first level, a user opens (step 101) the Carrots&Cake (labelled as C&C in FIGS. 1A and 1B) application on the user's client data processing device. This user could be, for example, a parent or guardian of the child who will eventually use the client data processing device once the set up procedure in FIGS. 1A and 1B is completed. This application is the application which performs the functions illustrated in the third level of FIGS. 1A and 1B. Once the user opens the Carrots&Cake application, the user is presented with a Landing Page (step 102) and functionality proceeds to a Login page (step 103) after which, after the user logs in (via a user id and password, for example), the user returns to a Landing page (step 102).

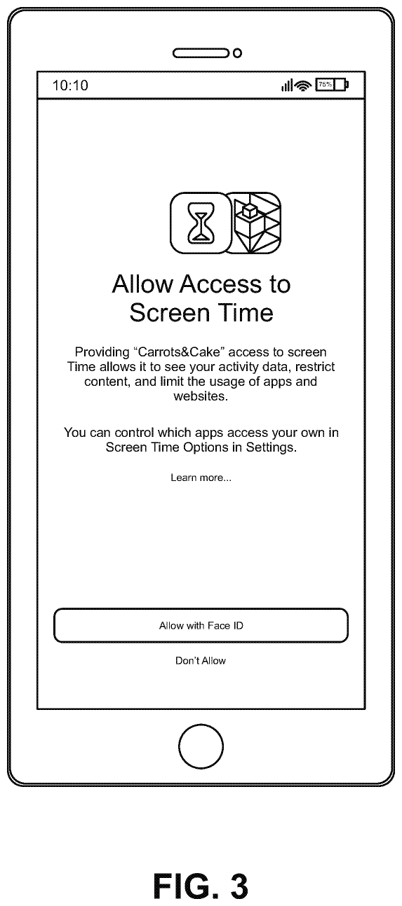

The user is then presented (step 104) with a screen (see client device screen shot in FIG. 3) where the user is asked whether the user gives the user's permission for the data processing system to access the user's Screen Time functionality. If no such permission is received, this function is retried at step 105, and when the user has successfully given the user's permission, control flows to step 106 where the user provides the child's nickname and year of birth. For privacy reasons, for example, it may be preferred not to provide the child's actual name or specific birthday (day, month, year) but instead only to provide a nickname and year of birth for the child who will eventually use the client device once the device is set up. The child nickname and year of birth is then stored by the Carrots&Cake application (step 107 at the third level of FIGS. 1A and 1B).

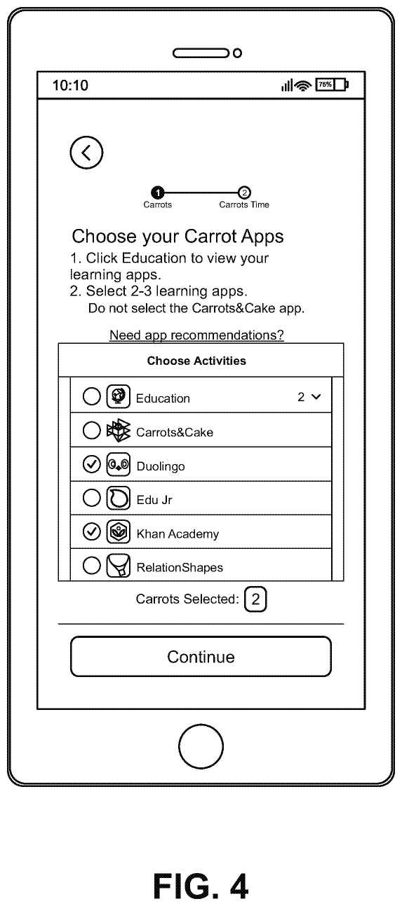

Control then flows to step 108 at the top level of FIGS. 1A and 1B where the user (again the parent or guardian user, usually) chooses the specific learning (educational) applications which the parent user would like the child user to use during an educational portion of the application blocking schedule (an application is also known as by its shorthand name as an “app” as used in FIGS. 1A and 1B). This could be an application which runs on the client device or it could be a World Wide Web site where the learning application may be located. See FIG. 4 which shows a screen shot which is displayed to the user at this point in the process. As shown in FIG. 4, the user is asked to select, for example, one, two or three educational applications (these could include the educational apps Duolingo, Khan Academy or Edu Jr). In response to the selection made by the user at step 108, control flows to step 109 where the Apple Screen Time API (application programming interface) provides tokens to the Carrots&Cake app, where one such token corresponds to each educational application selected at step 108 (one token corresponds to one educational application and another token corresponds to another education application). The Carrots&Cake app receives the tokens and stores them (step 110) and labels them as “carrots” meaning that the tokens correspond to educational apps. The Carrots&Cake app therefore keeps track of which apps in the schedule are educational apps. It should be noted that educational apps are used in the preferred embodiment, as the first type of app, but this first type of app could be apps of a different nature other than educational, such as, for example, business related apps, music related apps or the like. The first type of app is basically the apps that a user would like to use first, before any other apps are used.

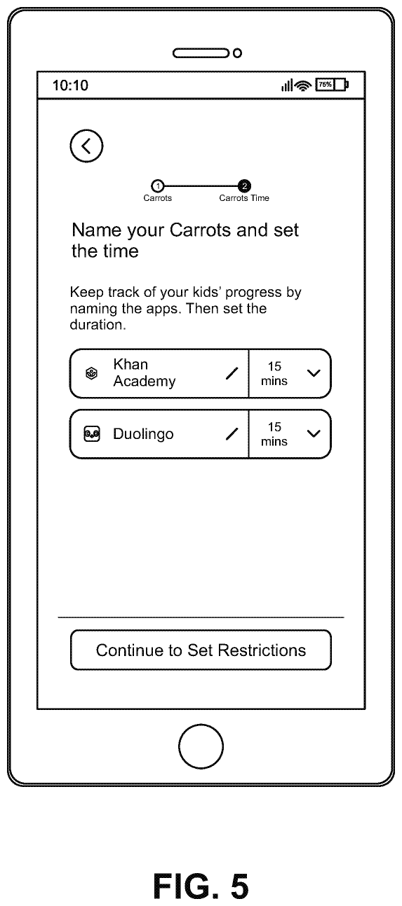

Control then flows to step 111 at the first level of FIGS. 1A and 1B where the user is prompted (via the screen prompt of FIG. 5) to select the names of the educational apps that were selected at step 108 and also to select the time for which each selected educational app must be used for, according to the application blocking schedule that is being set up. For example, the user could name the Khan Academy app as “Khan Academy” and the user could select 15 minutes for the time in which the child user must use the Khan Academy app before the child user can use any other of the selected apps. Likewise, the user could name the Duolingo app as “Duolingo” and the user could select 15 minutes (or another time period, such as 10 minutes) for the time in which the child user must use the Duolingo app after the child user has used the Khan Academy app for the 15 minutes time period. Accordingly, a sequence of permitted use, of specific educational data processing applications, is being set up, where the sequence includes an identify of the specific educational application and a time period assigned to each such specific educational application and an ordering of the specific educational applications (e.g., one specific educational application must be used first, and then when the specified time period elapses, the other specific educational application must be used second for the specified time period). These time periods are labelled as “carrot time” in step 111 of FIGS. 1A and 1B, meaning that they are times when the child user is required to carry out educational activities. It should be noted, as was explained above, that the child user can switch between the educational applications, it is not required for the child user to complete the time period for the first educational application before the child user moves on to the second educational application. The condition being enforced here is that the child user is not allowed to move on to a non-educational application until all of the specified educational applications have been completed.

Once the user makes the selections at step 111, control flows to step 112 where the Carrots&Cake app assigns the time and name (selected at step 111) against the stored tokens that were previously stored at step 110.

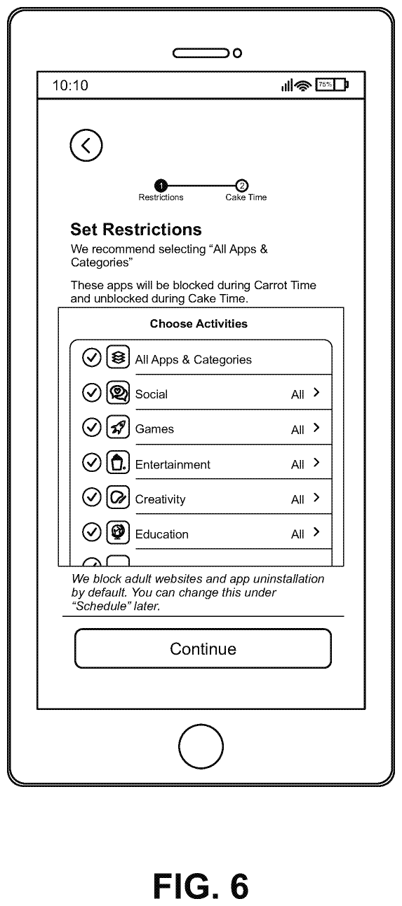

Control then flows to step 113 where the screen prompt of FIG. 6 is displayed on the client device, which prompts the user to select the apps (or Web sites) which should be blocked during the carrot time (during the time when the child user is using the educational apps). As shown in FIG. 6, the parent user is encouraged to select all of the apps so that the child user can only use the specific educational apps during the carrot time. However, it could be the case that the parent/guardian user wants to allow the child user to select specific apps, such as, for example, a clock or calendar app, during the carrot time. These apps which are to be blocked are the apps of a second type, where the apps of the second type are the apps which are not to be used until a time period in which the apps of the first type have been used. In the preferred embodiment, these apps of the second type are non-educational apps, such as entertainment type apps, such as watching fun videos, playing non-educational games, etc.

In response to the selection made by the user at step 113, control flows to step 114 where the Apple Screen Time API provides tokens to the Carrots&Cake app, where one such token corresponds to each application selected at step 113. The Carrots&Cake app receives the tokens and stores them (step 115) and labels them as “cake” meaning that the tokens correspond to non-educational apps. The Carrots&Cake app therefore keeps track of which apps in the schedule are not educational apps, and which therefore cannot be used during the educational learning time.

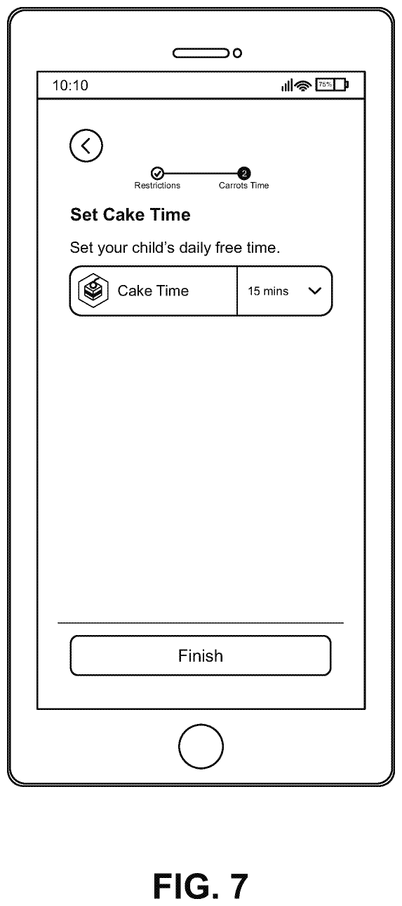

Control then flows to step 116, in the first level of FIGS. 1A and 1B, where the parent/guardian user can select (via a screen prompt as shown in FIG. 7) a free time in which the child user can select other apps that the child user would like to use, other than educational apps, for a set time period, which the parent/guardian user selects at step 116. This is called “cake time” in FIGS. 1A and 1B. This time period is then stored by the Carrots&Cake app at step 117.

Control then flows to step 118 where the Carrots&Cake app creates a schedule, using the above data, for the particular child user for which the parent/guardian user has been entering data for. Then, at step 119, in response to the schedule being created, the Apple Screen time functionality at the second level receives the stored tokens associated with the educational apps and uses them to create a Device Activity Event for each particular educational (or carrot) app. A Device Activity Event is an event created by the Apple Screen Time software, as is well known. The child user will not see these events on the screen of the child user device, these events happen behind the scenes and do not appear on screen. They are events which pass between the software levels and originate at the second level (e.g., Apple Screen Time level). The event tells the iOS (the Apple operating system) of the device being used by the child user to monitor app usage, from app tokens for a specific period of time (e.g., carrot time). That is, the device activity event monitors the time period that a user is using a particular app and will provide a notification event once the user has used the app for a specified period of time (e.g., “please let us know when the user has used app 1 for 5 minutes”).

Control then flows to step 120 where the Carrot&Cake app determines whether the parent user is logged in. If it is determined at step 120 that the parent user is not logged in, the schedule is paused (step 121) and if it is determined at step 120 that the parent user is logged in, an email address is stored and the schedule is activated (step 122). If the parent user is not logged in, the parent user can log in by entering an email address and password at a screen that will be presented by the third level app on the parent user's device, where the parent user has already registered for access. Where the parent user has not yet registered, the third level app would store the email address at 122 when activating the schedule at 122. Accordingly, schedule activation depends upon the parent user being logged in, and the parent user can only be logged in if the parent user is a registered user. If the parent user is not a registered user, then the third level app also presents a registration screen to the user device so that the parent user can register by entering appropriate email address and password selection data.

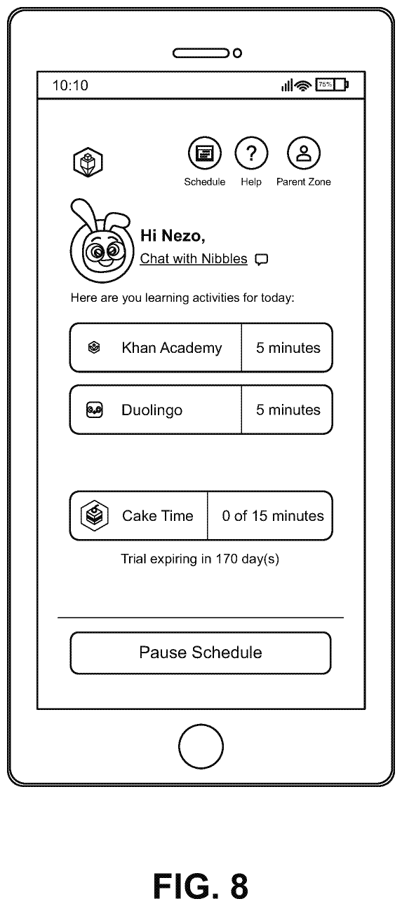

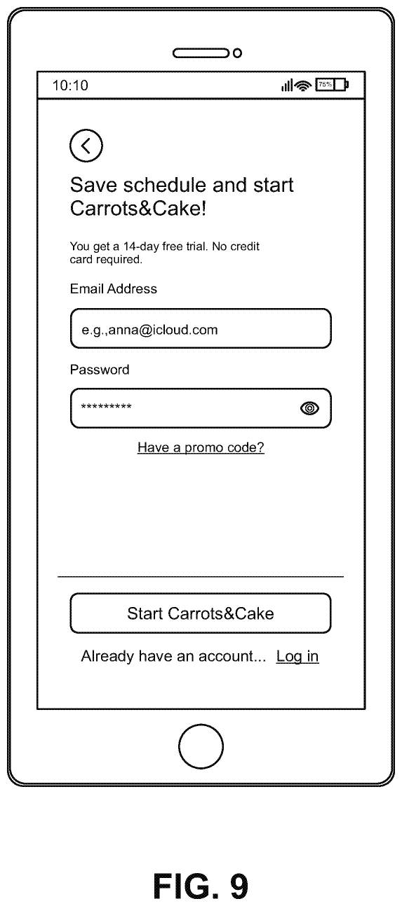

Control then flows to step 123 at the first level and where it is determined whether the parent user is logged in, and if so, the app schedule is activated at step 124, and where the parent user is not logged in, the screen shot in FIG. 8 is displayed on the user device where the parent user registers at step 125 or logs in at step 126 where the user has already registered, and then control flows to step 124 where the schedule is activated. Once the schedule is activated, the user device displays (step 127) the screen shot shown in FIG. 9 which shows a dashboard for the child user (the child user will see this when the child user begins accessing the applications after the parent user has set up the application blocking schedule), which informs the child user of which learning apps the child user must perform, in what order, and for how long must the child user use each listed learning app. The dashboard also tells the child user how much cake time the child user will have (time for the child user to use non-educational apps), after the child user has used the sequence of educational apps.

Accordingly, during schedule configurations, two type of app tokens are used.
1—Carrot tokens—Parent user can select as many as he/she needs and will configure “App name” and separate time for each carrot app
2—Cake tokens—Parent user can select as many tokens as he/she needs but in a single step and can configure a single time period to apply to all of the cake (non-educational) applications which are to be blocked during the educational time of the schedule.

Accordingly, at the iOS level, all apps are treated in the same manner, but the third level app segregates apps based on the parent user choice of whether an app is a carrot app or a cake app. And when a parent user selects a plurality of carrot apps, the parent user can select a different time period for each such carrot app in the plurality of carrot apps. And after configuring the carrot apps, the parent user will move to the cake app configuration and the parent user can select all apps at once, for example, that are not carrot apps, and set one single time period to apply to all of such latter apps. This allows the parent user to enforce, upon the child user, an application schedule whereby the child user has to spend a parent-specified time for each of N carrot apps, and once the child user has spent the specific time period for each of the N carrot apps, the child user can be rewarded by being allowed, according to the enforced application blocking schedule, to have X minutes to spent on every (already installed) app of the plurality of cake time apps.

A shield can be activated by the second level functionality, as will be described below, on any app either carrot app or cake app, to provide an application blocking functionality. Accordingly, when, according to the set application blocking schedule, carrot time is still remaining, then the shield is applied to the cake apps, and then when all carrot time is spent by the child user then the shield is lifted on the cake apps, thus allowing them to be used for the single time period X (e.g., the child user now has 20 minutes to use any non-educational app that the child user wants in whatever order the child user wants, and in whatever duration for each such non-educational app that the child user wants).

FIGS. 1A and 1B's flow chart flow process steps are now completed, and the child user's device, which also runs the third level app, has now been set up for the enforced app blocking schedule.

FIGS. 2A and 2B is an exemplary flow diagram showing the steps which are carried out after the child's user device, running the third level app, has been set up according to the process of FIGS. 1A and 1B.

At the top level at the far top left of FIGS. 1A and 1B, when the app blocking schedule is activated (step 201), control flows to step 202 where the carrot (e.g., educational application) schedule is triggered at the Carrots&Cake (e.g., third level) app at the bottom level of FIGS. 2A and 2B. Where the app blocking schedule is not activated (inactive), control flows to step 203 where the blocking schedule is not triggered. When the schedule is triggered, the Carrots&Cake app sends a message to the Apple Screen Time (operating system) in the middle (or second) level of FIGS. 2A and 2B, this message has content which informs the operating system (OS) that “this is carrot app 1, here is its token, and please monitor the usage of app 1 and please inform me when app 1 has been used for the preset time period for app 1, e.g., 10 minutes”. The message also has content which informs the OS that, for example, “this is carrot app 2, here is its token, and please monitor the usage of app 2 and please inform me when app 2 has been used for the present time period for app 2 of, e.g., 15 minutes.

In response to receiving these messages, the Apple Screen Time software creates (step 204) device activity events, which were described above with reference to FIGS. 1A and 1B, for each of the educational (carrot) apps, to achieve the monitoring and alert functions mentioned just above for each app.

The third level app also sends the OS a message containing the tokens for the cake apps which are to be blocked and the time period over which the cake apps are to be blocked and, next, at step 205, the Apple Screen Time middle (second) level OS software functionality, in response to this message, activates a shield for the cake apps (that is, the apps which are not the selected educational apps, selected according to the schedule that was set up in accordance with FIGS. 1A and 1B). This is achieved by the OS creating a type of device activity event which is able to block all apps from being used for which tokens are provided to the OS by an application, for a time period that is also provided to the OS. Activating a shield means that Apple Screen Time will produce a blocking screen on an iOS device when a user tries to select an app (the user taps on an app's icon) which is currently blocked (the icon for the app on the display screen will be greyed out showing that it is blocked). The blocking screen will contain a message, which may be set by the app developer, to tell the user that the app is currently blocked, and thus cannot be accessed at the present time. While Apple Screen Time has been described in the preferred embodiment for implementing the second level, other platforms may use a different software package, where the Apple platform is not being used.

Accordingly, the mechanism for performing the app monitoring and alert functions, as well as the mechanism for performing the app blocking functions, are carried out at the second, or OS, level, whereas the programmed logic for informing the OS of which applications are to be monitored, and for how long, and which applications are to be blocked, and for how long, are provided by the third, or app, level.

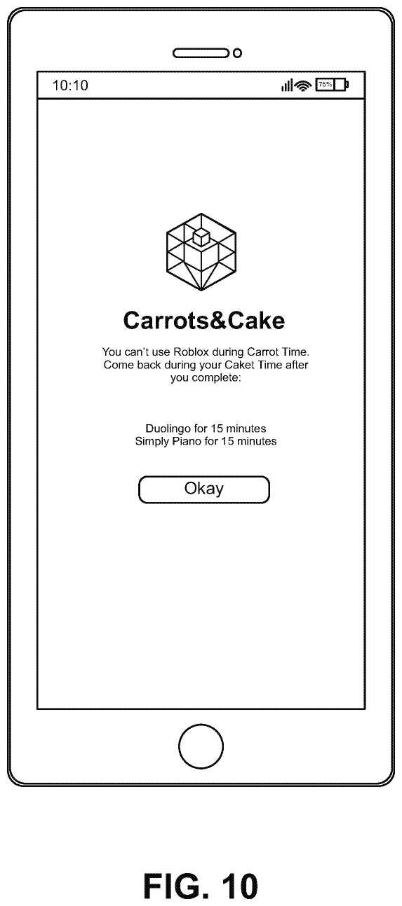

Control then flows to step 206 where the cake apps are blocked and the carrot apps are available on the child user's device. See, for example, the screen shot of FIG. 10, which informs the child user that the child user cannot use the non-educational app, Roblox, during the time when the child user is supposed to be using the educational apps. The screen shot also provides a reminder to the child user of the schedule of educational (carrot) apps that is already set up and that the child user is to follow.

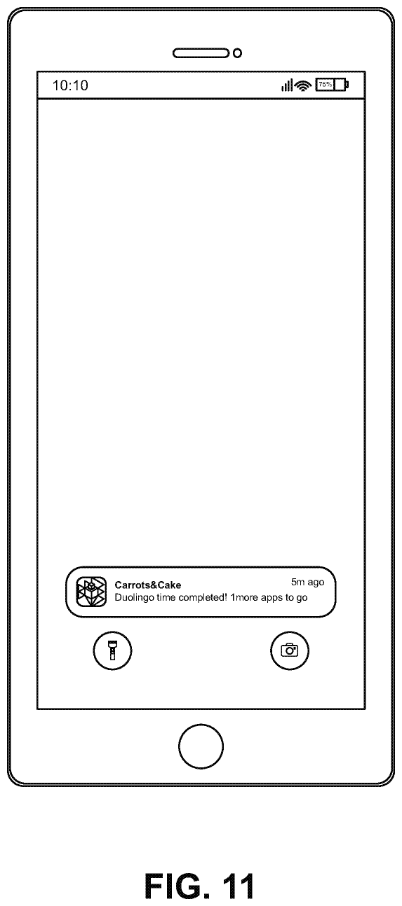

Control then flows to step 207 where the child user spends time on the carrot app (educational app) that is currently in the blocking schedule for the child user to follow (the child user can move between learning apps, spending a few minutes in each learning app, or the child user can use the learning apps sequentially, using all of the time allotted in the schedule to that learning app in one session). Then, when the time period for the first educational app has elapsed, at step 208, the Apple Screen Time functionality sends an event message to the user device to inform the user that the first learning app has been completed, a notification screen shot (see FIG. 11) is displayed (step 209), to inform the child user that the first learning app is completed (the preset time period for the first learning app in the application blocking schedule has now elapsed). Likewise, when the child user has spent the allocated time for the second learning app, the Apple Screen Time functionality detects this, and sends an event message to the data processing device at the first level, to indicate this fact, and a corresponding message for the second learning app being completed is then displayed.

At step 210, it is determined whether there are any further carrot apps in the blocking schedule (“is this the last carrot?”). That is, it is determined whether the learning app that the user is currently using is the last learning app in the schedule. If there are no further carrot apps in the blocking schedule, control flows directly to step 216 where the carrot portion of the application blocking schedule is completed and blocked. This means that the child user has spent the allotted time (allotted in the schedule) for each of the learning apps in the schedule, and therefore, the learning portion of the schedule is completed.

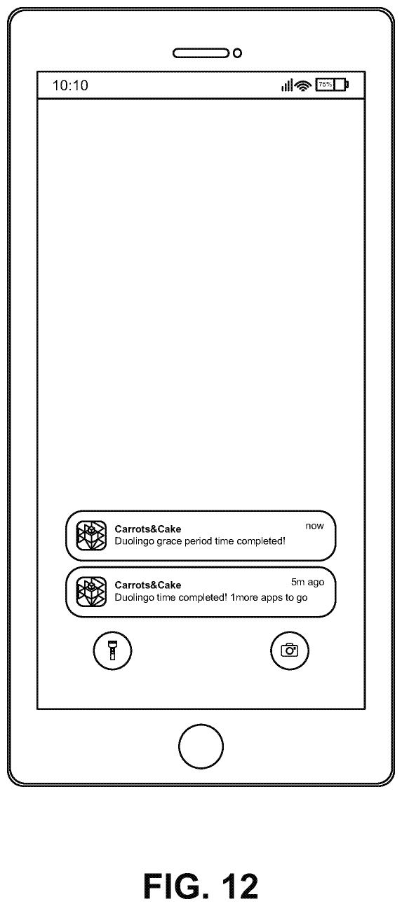

If, at step 210, this current learning app is not the last carrot application in the application blocking schedule, then flow proceeds to step 211 where the child user may continue to use the first learning app, even though the present time period for that first learning app has elapsed (at step 212, Apple Screen Time sends an event message to the child user data processing device to set a grace period of, for example, 5 minutes (in response to a grace period event being triggered by the third level app (step 231), where the child user can continue to use the first learning app in the schedule for a further 5 minutes. Then, at step 213, when the further 5 minute grace period has elapsed, the Apple Screen Time functionality sends an event message to the user device to inform the user device of the 5 minute grace period having elapsed, and then the screen shot of FIG. 12 is displayed (step 214) on the screen by the client device, to inform the user that the time is now up for using the first learning app in the application blocking schedule that was preset in accordance with FIGS. 1A and 1B. Accordingly, when the set time period for the first learning app is used up, then the third level app allows the child user to use the first learning app for a further 5 minutes, for example (a grace period), and after that, the first learning app is blocked (shielded). At this point, all cake apps are blocked and also this first learning app is also blocked. This promotes better screen time habits and also makes sure that the child user does not spend too much time on any particular learning app. This creates a sort of study-play balance that the parent user is able to enforce by setting up the third level app in the desired way in the first place (as was described in conjunction with the app set-up procedure of FIGS. 1A and 1B).

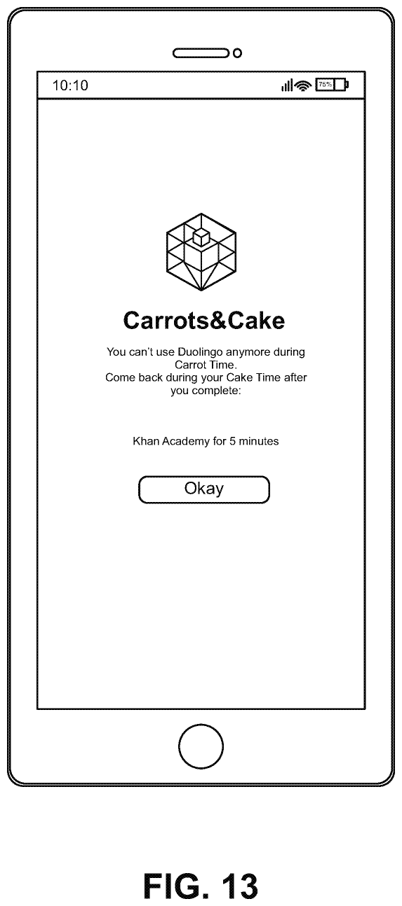

At step 215, the Apple Screen Time functionality activates the shield for the carrot app and control flows to step 216 where the client device displays the screen shot of FIG. 13 to inform the child user that the child user cannot use the first learning app any longer and that the child user should now use the second learning app in the application blocking schedule. It should be noted, however, as was described above, that the learning apps do not have to be used in this sequence, and the child user is free to move between the learning apps, using a few minutes on each learning app, and Apple Screen Time keeps track of how long the user has used which app and activates the shield for a particular learning app once the user has used the particular learning app for the preset time period.

At step 217, at the bottom level of FIGS. 2A and 2B, the cake schedule is triggered by the Carrots&Cake (third level) app, whereby the Carrots&Cake app sends an event message to the Apple Screen Time functionality. The Apple Screen Time functionality then, in response to this event message, creates device activity events for the cake apps at step 218, creates, at step 219, monitoring events for the cake apps at, for example, 5 minute intervals, and deactivates (step 220) the shield on the cake apps. Accordingly, the third level app is asking the second level OS to monitor the cake app usage at 218 for the total time period that was preset in the set up procedure, and the third level app is also asking the second level OS to release the blocking shield on the cake apps during this time period, and to notify the third level app when the time period is over.

Once Apple Screen Time deactivates the relevant shields, the client device has all of the cake apps unblocked (step 221). It could also be the case, alternatively, that the carrot apps are also unblocked here, which were previously blocked due to consumption of the 5 minute grace period.

Specifically, the Apple screen time API functionality at the second level sends “usage threshold completed” messages to the user device so when all the carrots (educational or learning apps) get completed (which means the third level app has received “usage threshold completed” messages for all the configured carrot apps) then the third level app will ask iOS to disable the shield (app blocker screen) hence all the greyed icons get enabled again. Then, the third level app asks the IOS to start monitoring the usage of all other apps (“Cake” time). Adding “device activity events” means to ask iOS to start monitoring app usage.

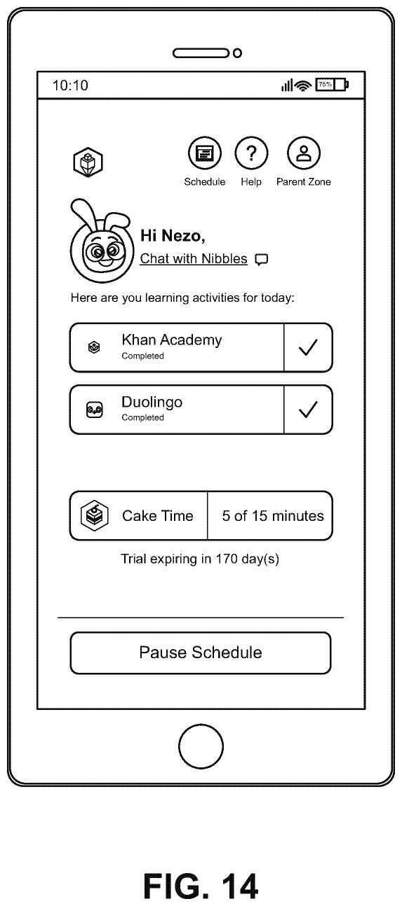

Apple Screen Time sends (at step 222) an event to the client device when each 5 minute interval is completed, and the client device displays (step 223) a screen shot (see FIG. 14) to inform the child user that the learning apps are completed and the cake time has begun and how much cake time is still remaining, and update is provided every 5 minutes, to let the child user know that another 5 minute interval of cake time has now elapsed, and how much cake time is still remaining.

At step 224, the Apple Screen Time functionality determines that the events for the cake time have completed, and at step 225, the Apple Screen Time functionality activates a shield for the carrot and cake apps.

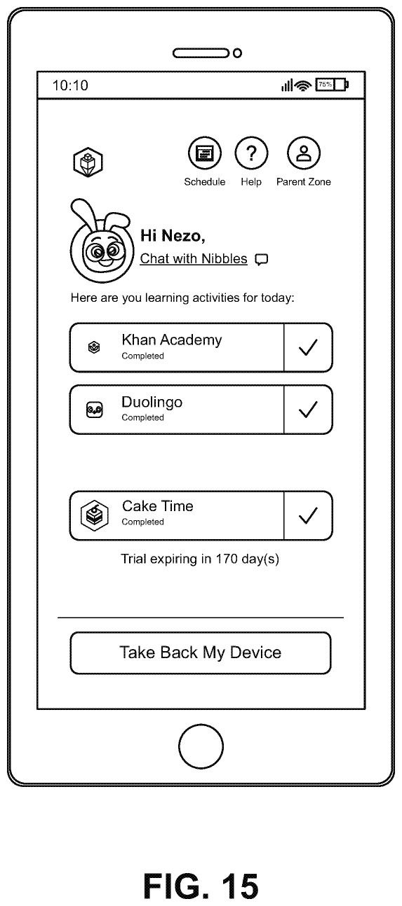

At step 226, the user device displays a screen shot (see FIG. 15) to inform the child user that the cake time is now completed, and at step 227, the carrot and cake apps are blocked. At step 228, the Carrots&Cake app deactivates the application blocking schedule, and at step 229, the parent user can optionally take back the device from the child user.

Finally, at step 230, all apps are unblocked. The application blocking schedule is now completed. The parent user can then use any app on the device without any app blocking.

This is related to a scenario where a parent user can configure the third level app on his/her device, activate the schedule and then give the device to a child so that the child can use the device in accordance with the app blocking schedule described above. When the child user has consumed all carrots and cake apps, then the device will be in complete lockdown mode, meaning all carrots and all cake apps are blocked (shield activates on all apps). So in that case if the parent wants to take back the device and wants to use it for the parent's own activities then he/she can deactivate the app blocking schedule completely and the device will be fully open and the shield gets deactivated.

It should be noted that the above-described preferred embodiment is only one example of the operation. In another example, a single time period can be assigned to all of the applications of the first type (the educational apps in the example above), rather than a respective time period assigned to each educational app, and in that case, the user can use any of the educational apps for the total time of the single time period (there is no monitoring as to which education app has been used for which individual time period, there is only a monitoring of when the single time period has elapsed for a user's use of any or all of the educational apps.

In a further example, while the preferred embodiment above describes the use of single time period for the non-educational apps (the cake apps), instead, respective time periods can be assigned to each of the non-educational apps, and a monitoring can be performed regarding how long the user has used each of the non-educational apps.

1. A method of scheduling a blocking of data processing application execution on a data processing device, comprising the steps of:
(a) receiving from an operating system a first plurality of tokens each token representing a respective one of a plurality of applications of a first type that have been selected by a user;
(b) storing the first plurality of tokens;
(c) receiving at least one application first type time period in which at least one of the plurality of applications of the first type is to be used for, such application first type time period having been selected by the user;
(d) assigning the at least one received application first type time period to at least one respective token each representing a respective one of the plurality of applications of the first type, by storing the at least one received application first type time period in association with each of the at least one respective tokens representing a respective one of the plurality of applications of the first type;
(e) receiving from the operating system a second plurality of tokens each token representing a respective one of a plurality of applications of a second type that have been selected by a user, the applications of the second type being applications which are to be blocked by the operating system while the applications of the first type are being used on the data processing device;
(f) storing the second plurality of tokens;
(g) sending to the operating system, an event message which includes the stored first plurality of tokens and the stored at least one application first type time period, in response to which the operating system creates a plurality of device activity events which trigger a monitoring function whereby the operating system monitors an execution on the data processing device of each application of the first type for the at least one first application type time period; and
(h) sending to the operating system an event message which includes the stored second plurality of tokens, in response to which the operating system creates a device activity event which sets up a blocking shield which prevents the applications of the second type from being executed by the data processing device during the at least one application first type time period when the plurality of applications of the first type are being used.

2. The method of claim 1 further comprising the steps of:
(i) receiving at least one application second type time period in which at least one of the plurality of applications of the second type is to be used for, such application second type time period being selected by the user; and
(j) assigning the at least one received application second type time period to at least one respective token representing a respective one of the plurality of applications of the second type, by storing the at least one received application second type time period in association with each of the at least one respective tokens representing a respective one of the plurality of applications of the second type.

3. The method of claim 2 wherein in response to the operating system providing a notification that each of the plurality of applications of the first type have been used for the at least one first application time period, sending to the operating system an event message which includes the at least one application second type time period.

4. The method of claim 3 wherein the event message which includes the at least one application second type time period causes the operating system to deactivate the blocking shield thus allowing the plurality of applications of the second type to be executed on the data processing device.

5. The method of claim 4 wherein the event message which includes the at least one application second type time period causes the operating system to trigger a monitoring function whereby the operating system monitors an execution on the data processing device of each application of the second type for the at least one application second type time period.

6. The method of claim 1 wherein step (c) receives an application first type time period for each of the plurality of applications of the first type, where the application first type time period for a first of the plurality of applications of the first type is different from the application first type time period for a second of the plurality of applications of the first type.

7. The method of claim 2 wherein step (j) receives one application second type time period for the plurality of applications of the second type.

8. The method of claim 1, wherein a graphical user interface screen is provided, requesting a user to enter an identifier for each of the plurality of applications of the first type and thereby designating such applications as being of the first type.

9. The method of claim 1, wherein a graphical user interface screen is provided, requesting a user to enter the at least one application first type time period.

10. The method of claim 1, wherein a graphical user interface screen is provided, requesting a user to enter an identifier for each of the plurality of applications of the second type and thereby designating such applications as being of the second type.

11. The method of claim 2, wherein a graphical user interface screen is provided, requesting a user to enter the at least one application second type time period.

12. A system comprising:
a processor;
a memory storing instructions that are executed on the processor, to perform the steps of:
(a) receiving from an operating system a first plurality of tokens each token representing a respective one of a plurality of applications of a first type that have been selected by a user;
(b) storing the first plurality of tokens;
(c) receiving at least one application first type time period in which at least one of the plurality of applications of the first type is to be used for, such application first type time period having been selected by the user;
(d) assigning the at least one received application first type time period to at least one respective token each representing a respective one of the plurality of applications of the first type, by storing the at least one received application first type time period in association with each of the at least one respective tokens representing a respective one of the plurality of applications of the first type;
(e) receiving from the operating system a second plurality of tokens each token representing a respective one of a plurality of applications of a second type that have been selected by a user, the applications of the second type being applications which are to be blocked by the operating system while the applications of the first type are being used on the data processing device;
(f) storing the second plurality of tokens;
(g) sending to the operating system, an event message which includes the stored first plurality of tokens and the stored at least one application first type time period, in response to which the operating system creates a plurality of device activity events which trigger a monitoring function whereby the operating system monitors an execution on the data processing device of each application of the first type for the at least one first application type time period; and
(h) sending to the operating system an event message which includes the stored second plurality of tokens, in response to which the operating system creates a device activity event which sets up a blocking shield which prevents the applications of the second type from being executed by the data processing device during the at least one application first type time period when the plurality of applications of the first type are being used.

13. A non-transitory computer-readable device having instructions stored thereon that, when executed by at least one computing device, cause the at least one computing device to perform operations comprising:
(a) receiving from an operating system a first plurality of tokens each token representing a respective one of a plurality of applications of a first type that have been selected by a user;
(b) storing the first plurality of tokens;
(c) receiving at least one application first type time period in which at least one of the plurality of applications of the first type is to be used for, such application first type time period having been selected by the user;
(d) assigning the at least one received application first type time period to at least one respective token each representing a respective one of the plurality of applications of the first type, by storing the at least one received application first type time period in association with each of the at least one respective tokens representing a respective one of the plurality of applications of the first type;
(e) receiving from the operating system a second plurality of tokens each token representing a respective one of a plurality of applications of a second type that have been selected by a user, the applications of the second type being applications which are to be blocked by the operating system while the applications of the first type are being used on the data processing device;
(f) storing the second plurality of tokens;
(g) sending to the operating system, an event message which includes the stored first plurality of tokens and the stored at least one application first type time period, in response to which the operating system creates a plurality of device activity events which trigger a monitoring function whereby the operating system monitors an execution on the data processing device of each application of the first type for the at least one first application type time period; and
(h) sending to the operating system an event message which includes the stored second plurality of tokens, in response to which the operating system creates a device activity event which sets up a blocking shield which prevents the applications of the second type from being executed by the data processing device during the at least one application first type time period when the plurality of applications of the first type are being used.
